(19) United States
(12) Patent Application Publication
(10) Pub. No.: US 2026/0051088 A1
(43) Pub. Date: Feb. 19, 2026

(54) TECHNIQUES FOR STOCHASTIC TEXTURE FILTERING THROUGH SINGLE-INSTRUCTION, MULTIPLE THREADS AND SINGLE INSTRUCTION, MULTIPLE DATA LANE COMMUNICATION

(71) Applicant: NVIDIA CORPORATION, Santa Clara, CA (US)

(72) Inventors: Tomas AKENINE-MOLLER, Lund (SE); Bartlomiej WRONSKI, Brooklyn, NY (US); Peter John MORLEY, Newport, RI (US); Matthew Milton PHARR, San Francisco, CA (US)

(21) Appl. No.: 19/097,660

(22) Filed: Apr. 1, 2025

Related U.S. Application Data
(60) Provisional application No. 63/683,150, filed on Aug. 14, 2024.
(60) Provisional application No. 63/733,962, filed on Dec. 13, 2024.

(51) Int. Cl. G06T 11/00; G06T 5/20; G06T 5/40

(52) U.S. Cl. CPC G06T 11/001; G06T 5/20; G06T 5/40

(57) ABSTRACT

The disclosed method for rendering graphics images includes, for each lane included in a plurality of lanes in a wave, sampling a texel based on a filter to generate a texel sample; for each lane included in the plurality of lanes, computing a filtered value based on a plurality of the texel samples that are read from a corresponding plurality of lanes based on a footprint associated with the lane; and rendering at least one portion of a graphics image based on the filtered values computed for the plurality of lanes.

### CROSS-REFERENCE TO RELATED APPLICATIONS

This application claims priority benefit of the U.S. Provisional Patent Application titled, “STOCHASTIC TEXTURE FILTERING QUAD/WAVE COMMUNICATION,” filed on Aug. 14, 2024, and having Ser. No. 63/683,150 and the U.S. Provisional Patent Application titled, “STOCHASTIC TEXTURE FILTERING THROUGH SINGLE-INSTRUCTION, MULTIPLE THREADS AND SINGLE INSTRUCTION, MULTIPLE DATA LANE COMMUNICATION,” filed on Dec. 13, 2024, and having Ser. No. 63/733,962. The subject matter of these related applications is hereby incorporated herein by reference.

### BACKGROUND

### Field of the Various Embodiments

Embodiments of the present disclosure relate generally to computer science and computer graphics and, more specifically, to techniques for stochastic texture filtering through single-instruction, multiple threads and single-instruction, multiple data lane communication.

### Description of the Related Art

Texture filtering is a technique in computer graphics that involves reconstructing texels for rendering arbitrary textured surfaces within an image. Conventional texture filtering techniques, such as bilinear or trilinear filtering, use predictable, step-by-step procedures known as deterministic algorithms to sample and interpolate texels in order to compute the colors of pixels within an image. While these techniques are well suited for hardware accelerated implementations, where specialized graphics hardware such as graphics processing units (GPUs) perform the texture filtering, conventional texture filter techniques face limitations when using artificial intelligence (AI) or machine learning based algorithms such as neural texture compression (NTC) to reduce the sizes of textures during the rendering process. In particular, the conventional texture filter techniques that use AI or machine learning based algorithms typically require substantial computational resources, which can limit their practicality in real-time video games, large-scale visualizations, and other applications that require fast and reliable processing.

Stochastic texture filtering (STF) was developed to alleviate the drawbacks of the above texture filtering techniques that use AI or machine learning based algorithms by providing an approach to select texels at random, instead of using GPU assistance in hardware accelerated implementations. Unlike traditional techniques that rely on predictable, step-by-step processes to display textures, STF introduces a controlled amount of randomness to the process to improve how textures look in rendered images. The added randomness helps to prevent common visual problems, such as blurriness, which occurs when the image appears unclear or out of focus, or unwanted repetitive patterns that do not appear realistic when textures are enlarged or viewed from various perspectives in the final rendered images.

One drawback of STF is that, under certain conditions, STF can introduce undesirable visual distortions that can reduce the overall quality of the rendered image. For example, when a texture needs to be greatly enlarged (also referred to as texture magnification) to fit a larger area or screen, STF can generate visual noise and artifacts. Similarly, when advanced lighting effects are applied, such as light effects that simulate how light interacts with surfaces to create depth and detail on a flat surface (also referred to as normal mapping) or how light reflects brightly off shiny surfaces (also referred to as specular lighting), STF can sometimes cause visual glitches or bright spots. These issues can reduce the overall quality of the displayed image.

Another drawback of NTC and similar methods is that decompressed texel values are not cached, which prevents efficient sharing between adjacent pixels during operations such as magnification. In addition, NTC and similar methods are decompressed using software running on the GPU instead of using fixed-function texture decompression hardware, which results in increased computational overhead. performing bilinear interpolation also requires 2×2 texture lookups, which needs additional resources.

As the foregoing illustrates, what is needed in the art are more effective techniques for texture filtering.

### SUMMARY

One embodiment of the present disclosure sets forth a computer-implemented method for rendering graphics images. The method includes, for each lane included in a plurality of lanes in a wave, sampling a texel based on a filter to generate a texel sample. The method further includes, for each lane included in the plurality of lanes, computing a filtered value based on a plurality of the texel samples that are read from a corresponding plurality of lanes based on a footprint associated with the lane. In addition, the method includes rendering at least one portion of a graphics image based on the filtered values computed for the plurality of lanes.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, visual artifacts and noise commonly associated with stochastic texture filtering are reduced relative to conventional filtering approaches, particularly under conditions of magnification or when nonlinear shading, such as normal mapping or specular highlights, are present. By facilitating efficient sharing and reuse of texture samples across neighboring pixels, the disclosed techniques can be used to generate images that are relatively close in appearance to images generated using hardware filters. Furthermore, the disclosed techniques can achieve rendering improvements while maintaining a relatively low computational overhead, including no additional texture lookup cost compared to conventional STF. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the present embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram illustrating an exemplar cloud computing system, according to various embodiments;

FIG. 5 illustrates how texture filtering can be performed using deterministic square footprints and pseudorandom sparse footprints for texel sharing within a wave, according to various embodiments;

FIG. 6 illustrates two exemplar techniques for defining 2×2 footprints in a wave of size 16 arranged as a 4×4 grid of lanes, according to various embodiments;

FIG. 7 illustrates exemplar texture filtering results generated using various techniques, according to various embodiments;

FIG. 8 is a more detailed illustration of the footprint generator of FIG. 1, according to various embodiments;

FIG. 9 is a flow diagram of method steps for generating and optimizing pseudo-random footprints for texel sharing within a wave, according to various embodiments; and

FIG. 10 is a flow diagram of method steps for performing rendering with texel sharing between lanes, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for improving texture filtering by utilizing stochastic sampling in conjunction with inter-thread communication in graphics processing units (GPUs). In some embodiments, a rendering application stochastically samples a first texel using a filter footprint that spans multiple threads or processing lanes, which can be implemented in software and/or hardware. The filter footprint, which can be square or pseudo-random in design, defines which pixels in a wave can be accessed to retrieve previously computed values, e.g., weights or texel values. For example, a square footprint accesses the pixels in the wave with a square configuration, while a pseudo-random footprint introduces controlled randomness sampling to minimize regular sampling patterns that can lead to artifacts. The rendering application uses the filter footprint to access additional texels from neighboring threads using inter-thread communication enabled by the single instruction multiple threads (SIMT) and/or single instruction multiple data (SIMD) architectures in a GPU. Then, the rendering application assigns to each texel sample a weight calculated using a probability distribution function (PDF) that shows the probability of sampling that texel based on the filter footprint. The application normalizes the weights and applies the normalized weights to each texel to compute a weighted average, which can in turn be used to compute a pixel color.

The texture filtering techniques of the present disclosure have many real-world applications. For example, the texture filtering techniques can be used during the rendering of an image or the frames of a video. As another example, the texture filtering techniques can be used during the rendering of the frames of a video game.

The above examples are not in any way intended to be limiting. As persons skilled in the art will appreciate, as a general matter, the texture filtering techniques described herein can be implemented in any application where texture filtering is required or useful.

### System Overview

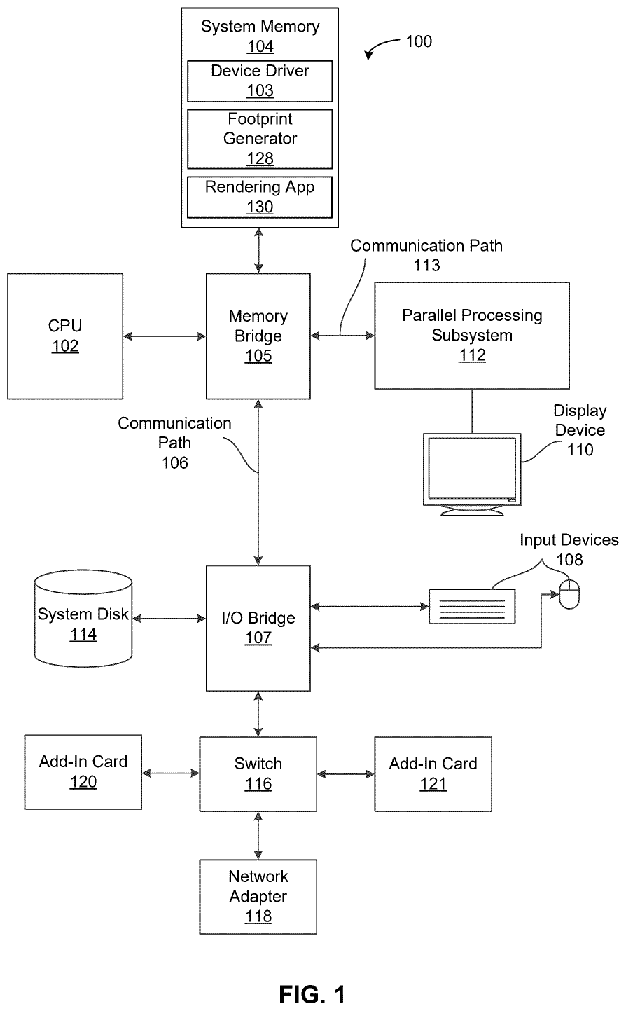

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, the computer system 100 is a server machine operating in a data center or a cloud computing environment that provides scalable computing resources as a service over a network.

In various embodiments, the computer system 100 includes, without limitation, a central processing unit (CPU) 102 and a system memory 104 coupled to a parallel processing subsystem 112 via a memory bridge 105 and a communication path 113. The memory bridge 105 is further coupled to an I/O (input/output) bridge 107 via a communication path 106, and the I/O bridge 107 is, in turn, coupled to a switch 116.

In one embodiment, the I/O bridge 107 is configured to receive user input information from optional input devices 108, such as a keyboard or a mouse, and forward the input information to CPU 102 for processing via the communication path 106 and the memory bridge 105. In some embodiments, the computer system 100 may be a server machine in a cloud computing environment. In such embodiments, the computer system 100 may not have the input devices 108. Instead, the computer system 100 may receive equivalent input information by receiving commands in the form of messages transmitted over a network and received via the network adapter 118. In one embodiment, the switch 116 is configured to provide connections between the I/O bridge 107 and other components of the computer system 100, such as a network adapter 118 and various add-in cards 120 and 121.

In one embodiment, the I/O bridge 107 is coupled to a system disk 114 that may be configured to store content and applications and data for use by the CPU 102 and the parallel processing subsystem 112. In one embodiment, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 107 as well.

In various embodiments, the memory bridge 105 may be a Northbridge chip, and the I/O bridge 107 may be a Southbridge chip. In addition, the communication paths 106 and 113, as well as other communication paths within the computer system 100, may be implemented using any technically suitable protocols, including, without limitation, AGP (Accelerated Graphics Port), HyperTransport, or any other bus or point-to-point communication protocol known in the art.

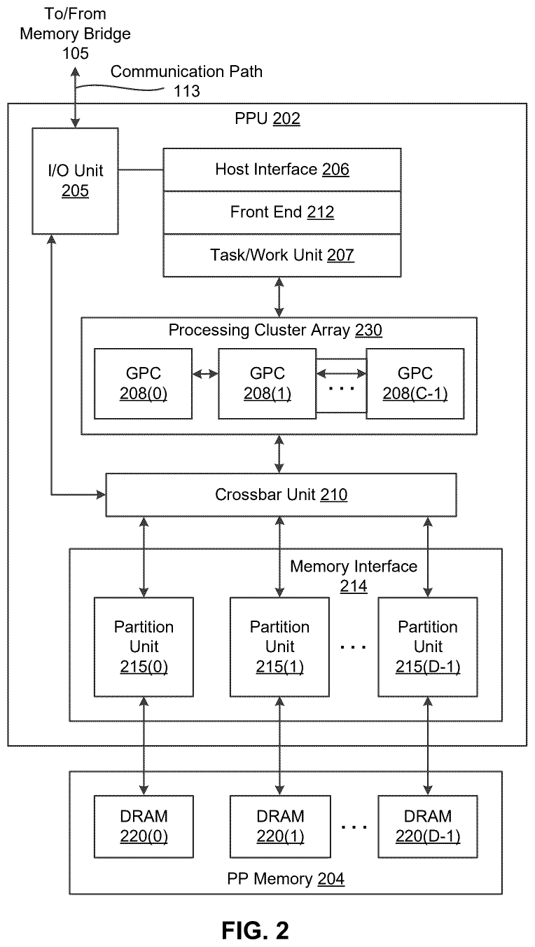

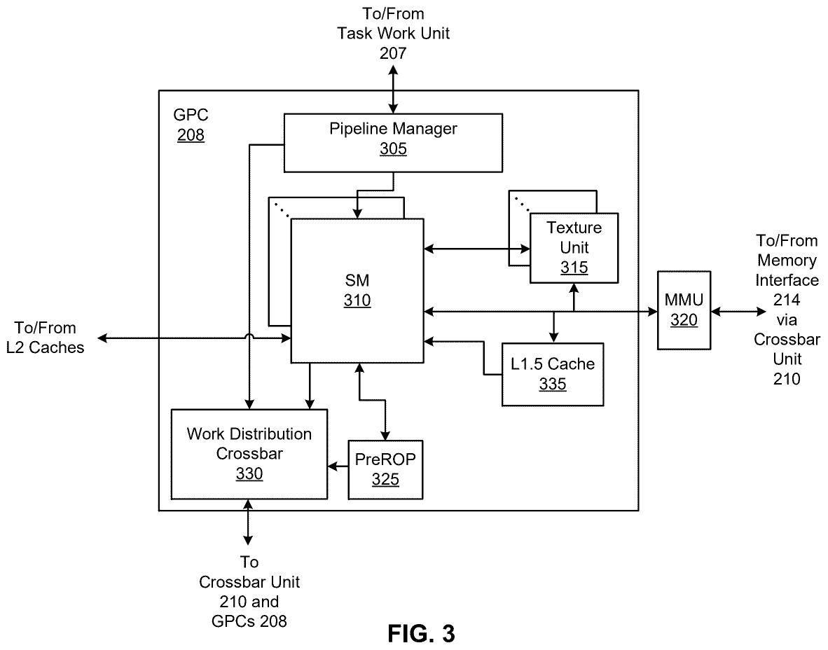

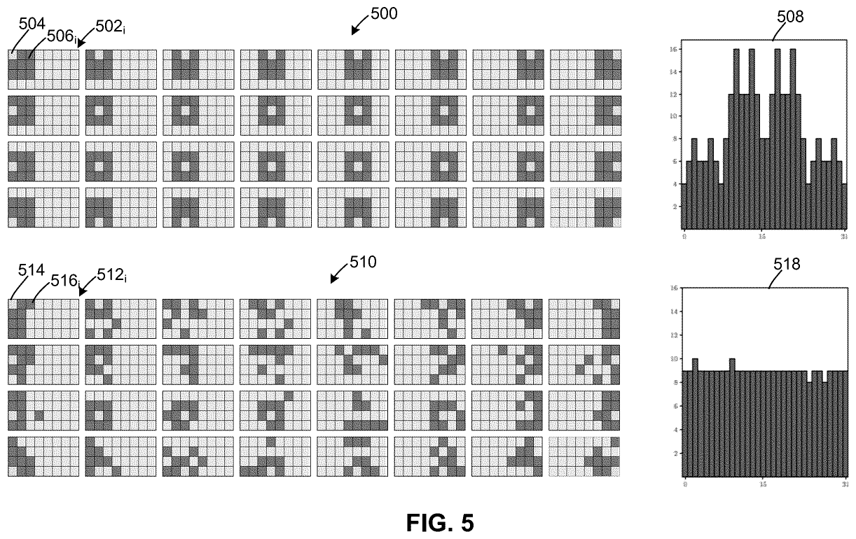

In some embodiments, the parallel processing subsystem 112 comprises a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within the parallel processing subsystem 112. In other embodiments, the parallel processing subsystem 112 incorporates circuitry optimized for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and compute processing operations. The system memory 104 includes at least one device driver 103 configured to manage the processing operations of the one or more PPUs within parallel processing subsystem 112. In addition, the system memory 104 includes a footprint generator 128 and rendering application 130. The footprint generator 128 is an application that generates sets of pseudo-random footprints for use in the texture filtering techniques disclosed herein, as described below in conjunction with FIGS. 5-9. The rendering application 130 can be any technically feasible application that renders virtual three-dimensional (3D) scenes via using the texture filtering techniques disclosed herein. For example, the rendering application 130 could be a gaming application or a rendering application that is used in film production. Although described herein primarily with respect to the footprint generator 128 and the rendering application 130, techniques disclosed herein can also be implemented, either entirely or in part, in other software and/or hardware, such as in the parallel processing subsystem 112.

In various embodiments, the parallel processing subsystem 112 may be integrated with one or more of the other elements of FIG. 1 to form a single system. For example, the parallel processing subsystem 112 may be integrated with the CPU 102 and other connection circuitry on a single chip to form a system on chip (SoC).

In one embodiment, the CPU 102 is the master processor of the computer system 100, controlling and coordinating operations of other system components. In one embodiment, the CPU 102 issues commands that control the operation of PPUs. In some embodiments, the communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, the system memory 104 could be connected to the CPU 102 directly rather than through the memory bridge 105, and other devices would communicate with the system memory 104 via the memory bridge 105 and the CPU 102. In other embodiments, the parallel processing subsystem 112 may be connected to the I/O bridge 107 or directly to the CPU 102, rather than to the memory bridge 105. In still other embodiments, the I/O bridge 107 and the memory bridge 105 may be integrated into a single chip instead of existing as one or more discrete devices. In certain embodiments, one or more components shown in FIG. 1 may not be present. For example, the switch 116 could be eliminated, and the network adapter 118 and the add-in cards 120, 121 would connect directly to the I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in some embodiments. For example, the parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 may include any number of PPUs 202. As shown, the PPU 202 is coupled to a local parallel processing (PP) memory 204. The PPU 202 and PP memory 204 may be implemented using one or more integrated circuit devices, such as programmable processors, application specific integrated circuits (ASICs), or memory devices, or in any other technically feasible fashion.

In some embodiments, the PPU 202 comprises a GPU that may be configured to implement a graphics rendering pipeline to perform various operations related to generating pixel data based on graphics data supplied by the CPU 102 and/or system memory 104. When processing graphics data, the PP memory 204 can be used as graphics memory that stores one or more conventional frame buffers and, if needed, one or more other render targets as well. Among other things, the PP memory 204 may be used to store and update pixel data and deliver final pixel data or display frames to an optional display device 110 for display. In some embodiments, the PPU 202 also may be configured for general-purpose processing and compute operations. In some embodiments, the computer system 100 may be a server machine in a cloud computing environment. In such embodiments, the computer system 100 may not have a display device 110. Instead, the computer system 100 may generate equivalent output information by transmitting commands in the form of messages over a network via the network adapter 118.

In some embodiments, the CPU 102 is the master processor of computer system 100, controlling and coordinating operations of other system components. In one embodiment, the CPU 102 issues commands that control the operation of the PPU 202. In some embodiments, the CPU 102 writes a stream of commands for the PPU 202 to a data structure (not explicitly shown in either FIG. 1 or FIG. 2) that may be located in the system memory 104, the PP memory 204, or another storage location accessible to both the CPU 102 and the PPU 202. A pointer to the data structure is written to a command queue, also referred to herein as a pushbuffer, to initiate processing of the stream of commands in the data structure. In one embodiment, the PPU 202 reads command streams from the command queue and then executes commands asynchronously relative to the operation of the CPU 102. In embodiments where multiple pushbuffers are generated, execution priorities may be specified for each pushbuffer by an application program via device driver to control scheduling of the different pushbuffers.

In one embodiment, the PPU 202 includes an I/O (input/output) unit 205 that communicates with the rest of the computer system 100 via the communication path 113 and the memory bridge 105. In one embodiment, I/O unit 205 generates packets (or other signals) for transmission on the communication path 113 and also receives all incoming packets (or other signals) from the communication path 113, directing the incoming packets to appropriate components of the PPU 202. For example, commands related to processing tasks may be directed to a host interface 206, while commands related to memory operations (e.g., reading from or writing to PP memory 204) may be directed to a crossbar unit 210. In one embodiment, the host interface 206 reads each command queue and transmits the command stream stored in the command queue to a front end 212.

As mentioned above in conjunction with FIG. 1, the connection of the PPU 202 to the rest of the computer system 100 may be varied. In some embodiments, the parallel processing subsystem 112, which includes at least one PPU 202, is implemented as an add-in card that can be inserted into an expansion slot of the computer system 100. In other embodiments, the PPU 202 can be integrated on a single chip with a bus bridge, such as the memory bridge 105 or the I/O bridge 107. Again, in still other embodiments, some or all of the elements of the PPU 202 may be included along with the CPU 102 in a single integrated circuit or system of chip (SoC).

In one embodiment, the front end 212 transmits processing tasks received from the host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from the front end 212 and ensures that general processing clusters (GPCs) 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, the PPU 202 implements a highly parallel processing architecture based on a processing cluster array 230 that includes a set of C GPCs 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of the PP memory 204.

In one embodiment, a given GPC 208 may process data to be written to any of the DRAMs 220 within the PP memory 204. In one embodiment, the crossbar unit 210 is configured to route the output of each GPC 208 to the input of any partition unit 215 or to any other GPC 208 for further processing. The GPCs 208 communicate with the memory interface 214 via the crossbar unit 210 to read from or write to various DRAMs 220. In some embodiments, the crossbar unit 210 has a connection to the I/O unit 205, in addition to a connection to the PP memory 204 via the memory interface 214, thereby enabling the processing cores within the different GPCs 208 to communicate with the system memory 104 or other memory not local to the PPU 202. In the embodiment of FIG. 2, the crossbar unit 210 is directly connected with the I/O unit 205. In various embodiments, the crossbar unit 210 may use virtual channels to separate traffic streams between the GPCs 208 and the partition units 215.

In one embodiment, the GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, the PPU 202 is configured to transfer data from the system memory 104 and/or the PP memory 204 to one or more on-chip memory units, process the data, and write result data back to the system memory 104 and/or the PP memory 204. The result data may then be accessed by other system components, including the CPU 102, another PPU 202 within the parallel processing subsystem 112, or another parallel processing subsystem 112 within the computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, the GPC 208 includes, without limitation, a pipeline manager 305, one or more texture units 315, a preROP unit 325, a work distribution crossbar 330, and an L1.5 cache 335.

In one embodiment, the GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of the GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, the GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In some embodiments, a single SM 310 may simultaneously support multiple CTAs, where such CTAs are at the granularity at which work is distributed to the SMs 310.

In one embodiment, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

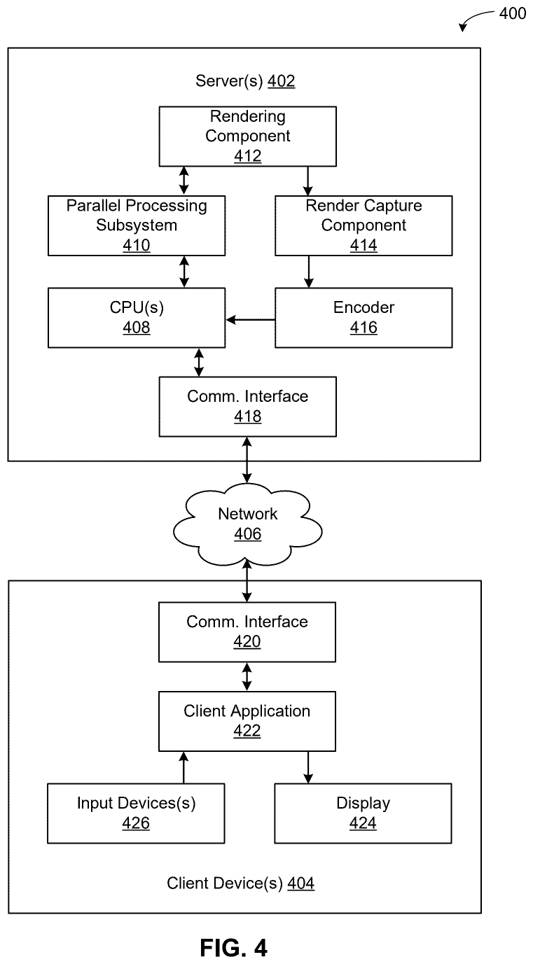

FIG. 4 is a block diagram illustrating an exemplar cloud computing system, according to various embodiments. As shown, a computing system 400 includes server(s) 402 that are in communication with client device(s) 404 via network(s) 406. Each of the server(s) 402 may include similar components, features, and/or functionality as the exemplar computer system 100, described above in conjunction with FIG. 1-3. Each of the server(s) 402 may be any technically feasible type of computer system, including, without limitation, a server machine or a server platform. Each of the client device(s) 404 may also include similar components, features, and/or functionality as the computer system 100, except each client device 404 executes a client application 422 rather than the rendering application 130. Each of the client device(s) 404 may be any technically feasible type of computer system including, without limitation, a desktop machine, a laptop machine, a hand-held/mobile device, and/or a wearable device. In some embodiments, one or more of the server(s) 402 and/or the client device(s) 404 may be replaced with virtualized processing environment(s), such as virtualized processing environment(s) provided by one or more VMs and/or containers that execute on underlying hardware system(s). The network(s) 406 may include any type of network(s), such as one or more local area networks (LANs) and/or wide area networks (WANs) (e.g., the Internet).

In some embodiments, the server(s) 402 may be included in a cloud computing system, such a public cloud, a private cloud, or a hybrid cloud, and/or in a distributed system. For example, the server(s) 402 could implement a cloud-based gaming platform that provides a game streaming service, also sometimes referred to as “cloud gaming,” “gaming on demand,” or “gaming-as-a-service.” In such a case, games that are stored and executed on the server(s) 402 are streamed as videos to the client device(s) 404 via client application(s) 422 running thereon. During game sessions, the client application(s) 422 handle user inputs and transmit those inputs to the server(s) 402 for in-game execution. Although cloud-based gaming platforms are described herein as a reference example, persons skilled in the art will appreciate that, as a general matter, the server(s) 402 may execute any technically feasible types of application(s), such as the design applications described above.

As shown, each of the client device(s) 404 includes input device(s) 426, the client application 422, a communication interface 420, and a display 424. The input device(s) 426 may include any type of device(s) for receiving user input, such as a keyboard, a mouse, a joystick, and/or a game controller. The client application 422 receives input data in response to user inputs at the input device(s) 426, transmits the input data to one of the server(s) 402 via the communication interface 420 (e.g., a network interface controller) and over the network(s) 406 (e.g., the Internet), receives encoded display data from the server 402, and decodes and causes the display data to be displayed on the display 424 (e.g., a cathode ray tube, liquid crystal display, light-emitting diode display, or the like). As such, more computationally intense computing and processing can be offloaded to the server(s) 402. For example, a game session could be streamed to the client device(s) 404 from the server(s) 402, thereby reducing the requirements of the client device(s) 404 for graphics processing and rendering.

As shown, each of the server(s) 402 includes a communication interface 418, CPU(s) 408, a parallel processing subsystem 410, a rendering component 412, a render capture component 414, and an encoder 416. Input data transmitted by the client device 404 to one of the server(s) 402 is received via the communication interface 418 (e.g., a network interface controller) and processed via the CPU(s) 408 and/or the parallel processing subsystem 410 included in that server 402, which correspond to the CPU 102 and the parallel processing subsystem 112, respectively, of the computer system 100 described above in conjunction with FIGS. 1-3. In some embodiments, the CPU(s) 408 may receive the input data, process the input data, and transmit data to the parallel processing subsystem 410. In turn, the parallel processing subsystem 410 renders one or more standalone images and/or image frames, such as the frames of a video game, based on the transmitted data.

Illustratively, the rendering component 412 employs the parallel processing subsystem 112 to render the result of processing the input data, and the render capture component 414 captures the rendering as display data (e.g., as image data capturing standalone image(s) and/or image frame(s)). The rendering performed by the rendering component 412 may include ray- or path-traced lighting and/or shadow effects, computed using one or more parallel processing units—such as GPUs, which may further employ the use of one or more dedicated hardware accelerators or processing cores to perform ray or path-tracing techniques—of the server 402. In some embodiments, the rendering component 412 performs rendering using the texture filtering techniques disclosed herein. Thereafter, the encoder 416 encodes display data capturing the rendering to generate encoded display data that is transmitted, over the network(s) 406 via the communication interface 418, to the client device(s) 404 for display to user(s). In some embodiments, the rendering component 412, the render capture component 414, and the encoder 416 may be included in the rendering application 130, described above in conjunction with FIG. 1.

Returning to the example of cloud gaming, during a game session, input data that is received by one of the server(s) 402 may be representative of movement of a character of the user in a game, firing a weapon, reloading, passing a ball, turning a vehicle, etc. In such a case, the rendering component 412 may generate a rendering of the game session that is representative of the result of the input data, and the render capture component 414 may capture the rendering of the game session as display data (e.g., as image data capturing rendered frames of the game session). Parallel processing (e.g., GPU) resources may be dedicated to each game session, or resource scheduling techniques may be employed to share parallel processing resources across multiple game sessions. In addition, the game session may be rendered using the texture filtering techniques disclosed herein. The rendered game session may then be encoded, by the encoder 416, to generate encoded display data that is transmitted over the network(s) 406 to one of the client device(s) 404 for decoding and output via the display 424 of that client device 404.

It will be appreciated that the architecture described herein is illustrative and that variations and modifications are possible. Among other things, any number of processing units, such as the SMs 310, texture units 315, or preROP units 325, described above in conjunction with FIG. 3, may be included within GPC 208.

### Stochastic Texture Filtering Through Single-Instruction, Multiple Threads and Single Instruction, Multiple Data Lane Communication

FIG. 5 illustrates how texture filtering can be performed using deterministic square footprints and pseudorandom sparse footprints for texel sharing within a wave, according to various embodiments. As shown, sets of footprints 500 and 510 indicate how texel samples can be shared among lanes in a wave executing on a processor, such as a GPU. Although described herein primarily with respect to GPUs as a reference example, techniques disclosed herein can be implemented using any suitable processor in some embodiments. Illustratively, the sets of footprints 500 and 510 include footprints 5021 (referred to herein collectively as footprints 502 and individually as a footprint 502) and footprints 5121 (referred to herein collectively as footprints 512 and individually as a footprint 512), respectively, for different lanes in a wave. Histograms 508 and 518 show the frequency of texel sample reuse per wave lane for each set of footprints 500 and 510, respectively.

Illustratively, the sets of footprints 500 and 510 are associated with a wave of size 32 and that is configured as 8×4 lanes. Each lane in a GPU is an execution thread. A set of lanes that execute concurrently in parallel collectively form a wave (also referred to as a “warp”), which is a basic unit of execution for GPU operations. For example, in some embodiments, the lanes of a wave can execute across the SMs 310 of a GPC 208, described above in conjunction with FIGS. 2-3. The illustrated 32 lanes in a wave can each be configured to process a different pixel in parallel, so that together the 32 waves process a grid of, for example, 16×2 or 8×4 pixels in parallel. In some embodiments, in addition to performing processing for a pixel, each lane can source texel values from other lanes in the wave based on a pre-determined sharing footprint, such as one of the footprints 502 or 512. The footprints can be either deterministic, for example, 2×2 or 3×3 squares as in the set of footprints 500 or pseudorandom, sparse footprints as in the set of footprints 510. In some embodiments, footprints can be designed according to the following criteria: (1) prefer lanes close to the current lane to improve the chances of sharing a useful texel value, (2) use the same sharing filter footprint size for all lanes inside a wave to avoid unnecessary thread divergence, and (3) maximize the variety of shared texel values between lanes.

Although the illustrated footprints are for a wave configuration of size 32, in some embodiments, the disclosed techniques can generally be applied to wave sizes of 8, 16, 64, or any other arrangement supported by a GPU. Although described with respect to using wave intrinsics to share texel samples among the lanes of a wave, in some embodiments, quad intrinsics can be used if the GPU only provides sub-group operations over 2×2 quads, even though wave intrinsics typically provide more flexibility to share texel samples among a larger set of lanes. Although described with respect to specific footprints 502 and 512 as reference examples, any suitable footprints can be used in some embodiments. Larger footprints, for example 3×3 or 4×4, generally allow more thorough sharing of contributing texels but can increase shading-time overhead. In some embodiments, any suitable footprint sizes and patterns can be selected to balance performance and filtering quality needs.

As shown, each lane in a wave, such as lane 504 or 514, acquires a single texel sample and also receives one or more texel samples from a set of contributing lanes, such as lanes 5061 (referred to herein collectively as lanes 506 and individually as a lane 506) for the lane 504 and lanes 5161 (referred to herein collectively as lanes 516 and individually as a lane 516) for the lane 514. In some embodiments, the texel samples can be transferred via wave intrinsics, which allow adjacent or nearby lanes to read coordinates and/or texel values without incurring additional memory bandwidth costs. The combined set of texel samples that contribute to each lane is referred to herein as a footprint.

In some embodiments, the GPU can store multiple candidate footprints for each pixel in a wave, and randomly select from candidate footprints for each frame or for each shading pass. In such cases, instead of assigning exactly one deterministically configured footprint (e.g., a 3×3 square or pseudorandom footprint) to each lane, the GPU can store a set of footprints that are valid for the pixel or lane. For each pixel, one footprint from the set of footprints can be randomly selected for use.

Two example approaches for defining footprints are shown in FIG. 5. For the deterministic square footprints 502, each target lane (e.g., lane 504 or 514) has 8 spatially adjacent contributor lanes to form a 3×3 square footprint that spans across a wave. For example, the lane 504 has 8 spatially adjacent contributor lanes 506. Deterministic square footprints provide localized texel reuse such that nearby lanes frequently sample the same regions in a texture. For the pseudo-random footprints 512, each target lane has 8 contributor lanes that are irregularly placed around the target lane. For example, the lane 514 has 8 contributor lanes 516 that are irregularly placed around the lane 514. The sparse pseudo-random footprints can distribute texel samples more randomly among lanes in a wave, thereby improving the denoising performance for image regions under magnification.

The histograms 508 and 518 show how many times a texel sample from a given wave lane (index from 0 to 31) is used by all the pixels in the wave for the set of square footprints 500 and the set of pseudo-random footprints 510, respectively. Illustratively, the frequency of reuse for each wave lane can be more uniform with pseudo-random footprints 512, which can prevent overusing of certain lanes. In deterministic footprints such as the footprints 502 in the set of square footprints 500, corner or edge lanes tend to be selected less frequently, producing larger variance in sample reuse. By contrast, pseudo-random footprints, such as the footprints 512 in the set of footprints 510, can balance the number of contributions of each lane to the target lane (e.g., the contributions of other lanes 516 to the lane 514), thereby reducing potential artifacts and improving overall image quality.

In some embodiments, once a lane has sampled its own texel, the lane acquires the sampled coordinates, probability distribution function (PDF) value, and texel values from the other lanes specified by the sharing footprint associated with the lane via wave intrinsics. The PDF value that is acquired from other lanes shows how likely it is to pick any particular texel from the texture, such that the average result of random picks converges to the true selected filtered value. In some embodiments, the lane can access values from other lanes in the sharing footprint by making WaveReadLaneAt(value, laneId) function calls. Wave intrinsics have relatively little overhead, because wave intrinsics are typically implemented as swap or shuffle instructions within a wave and thus cost only one instruction with no memory bandwidth impact. Further, texture filtering quality can be improved by sharing samples between pixels in a footprint.

In stochastic texture filtering, each pixel randomly selects a texel based on a PDF that reflects the contribution weights. For example, when approximating a bilinear filter stochastically, the probability of selecting one of the four nearest texels is proportional to the interpolation weight of texture coordinates (u, v).

After the lane i obtains a texel sample, the lane also retrieves integer coordinates (uᵢ, vᵢ) of texel xᵢ, PDF values, and texel values f(xᵢ) from other lanes in the footprint for the lane. The integer texel coordinates (uᵢ, vᵢ) are needed to compute the filter sampling PDF for the current lane. pᵢ(xᵢ) demonstrates the PDF value with which lane i within a filter footprint texel sample xᵢ, and p_{c}(xᵢ) is the PDF value assigned by the lane to texel xᵢ.

In some embodiments, determining a texel value for a lane includes computing, by the lane, a set of weights wᵢ associated with respective texels xᵢ. Each weight wᵢ indicates the contribution of the corresponding texel xᵢ to the final texel value of the lane according to the weighted importance sampling (WIS) estimator of Equation 1.

$${\sum }_{i}^{n} \frac{f ( {x}_{i} )}{{p}_{i} ( {x}_{i} )} / {\sum }_{i}^{n} \frac{{p}_{c} ( {x}_{i} )}{{p}_{i} ( {x}_{i} )} , \qquad Equation 1$$

where pᵢ is probability of sampling each xᵢ when one xᵢ is drawn from each of n PDFs pᵢ, and p_{c} is the PDF for sampling the filter at the current pixel. In operation, a lane can compute a weight to apply to each texel sample that is read from another lane in the footprint associated with the lane according to the WIS estimator of Equation 1; add the texel samples read from other lanes, weighted by the corresponding weights, together to obtain an intermediate result; add the weights to obtain an accumulation of weights; and divide the intermediate result by the accumulation of weights to compute a filtered value. The computed filtered value is a statistical estimate of a stochastically filtered texture that approximates the value of fully deterministic texture filtering by hardware. In some embodiments, to compute the filtered value, each lane can perform the operations of Algorithm 1. The weighted approach, described above, limits each output color to the convex hull of all contributed texels, preventing any filtered result from exceeding the minimum or maximum texel value among samples.

Algorithm 1.

```
// uv is in [0 ,1]\hat{ }2 and txDim is the texture resolution.
float texelFloatCoords = uv * txDim − float2 (0.5 f);
// (...) One −tap STF sampling with access of one texel.
// textureValue is the fetched / decompressed single texel.
// texelFloatCoords are the original floating − point coordinates for filtering.
// sampledTexelIntCoords are the integer coordinates of the STF − fetched texel.
float samplePdf = GetFilterPDF ( texelFloatCoords , sampledTexelIntCoords );
float4 textureValue = texture [ sampledTexelIntCoords ];
float4 result = 0.0f;
float weightAccum = 0.0f;
for ( uint idx = 0; idx < FOOTPRINT_SIZE ; ++ idx) {
  uint laneIdx = waveLaneSet [ currentLaneIdx ][ idx ];
  int2 coordOther = WaveReadLaneAt ( sampledTexelIntCoords , laneIdx );
  float otherPdf = WaveReadLaneAt ( samplePdf , laneIdx );
  float4 otherTextureValue = WaveReadLaneAt ( textureValue , laneIdx );
  float weight = GetFilterPDF ( texelFloatCoords , coordOther ) / otherPdf;
  result += otherTextureValue * weight;
  weightAccum += weight;
}
return result / weightAccum;
```

In Algorithm 1, the texel sharing footprint is encoded as a lookup table in the waveLaneSet array. If deterministic sharing footprints are used, the corresponding offsets may be computed at runtime. The number of loop iterations (FOOTPRINT_SIZE) is based on the size of the sharing footprints.

In Algorithm 1, the code uint laneIdx=waveLaneSet [currentLaneIdx][idx] is used to retrieve the ID of a lane in a footprint that is stored in a lookup table. In some embodiments, a lane can perform bit manipulations and arithmetic to compute the ID of each lane in the footprint, which is less computationally expensive than a lookup table. For example, for square 3×3 footprints, Algorithm 2 could be used to compute the ID of each lane in the footprint.

Algorithm 2.

```
const uint I = WaveGetLaneIndex( );
int t = I − ((((I >> 4) & 1) + ((I >> 3) & 1)) << 3);
uint baseIndex = t < 8 ? min(max(t − 1, 0), 5) : min(max(t − 1, 8), 13);
  for (uint y = 0; y < 3; y++)
  {
    for (uint x = 0; x < 3; x++)
    {
      uint offset = (y << 3) | x;
      uint laneIdx = baseIndex + offset;
      int2 coordOther = WaveReadLaneAt(sampledTexelIntCoords, laneIdx);
      float otherPdf = WaveReadLaneAt(samplePdf, laneIdx);
      float4 otherTextureValue = WaveReadLaneAt(stfTexelValue, laneIdx);
      float weight = _GetQuadShareWeight(texelFloatCoords, coordOther,
  otherPdf);
      result += otherTextureValue * weight;
      weightAccum += weight;
    }
  }
```

In some embodiments, to determine the ID of the lane in the footprint, a lane can perform a more efficient look-up in which a 32-bit value uses each bit to indicate whether the corresponding lane should be included or not. For example, in such cases, Algorithm 3 could be used to compute the ID of each lane in the footprint.

Algorithm 3.

```
uint pixelPattern = mPixelPattern;
while (pixelPattern != 0)
{
  // Find the first set bit, which corresponds to the pixel laneIdx we want to borrow from.
  laneIdx = firstbithigh(pixelPattern);
  // The usual WIS estimator code should follow here, i.e., the bit that starts with “int2
coordOther = ...” above.
  // Excluded for clarity.
    // Zero out this bit.
    pixelPattern = pixelPattern \hat{ } (1u << laneIdx);
}
```

Accordingly, to compute the final filtered texture value, some embodiments implement an WIS estimator, which can be written as shown in Equation 2. Equation 2 indicates that, when the lane aggregates n samples (uᵢ, vᵢ) from different PDFs pᵢ, the estimator for the filtered texture value can be expressed as

$$\frac{{\sum }_{i}^{n} {f}_{c} ( {u}_{i} , {v}_{i} ) {T}_{{u}_{i} , {v}_{i}} / {p}_{i} ( {u}_{i} , {v}_{i} )}{{\sum }_{i}^{n} {p}_{c} ( {u}_{i} , {v}_{i} ) / {p}_{i} ( {u}_{i} , {v}_{i} )} , \qquad Equation 2$$

where f_{c}(uᵢ, vᵢ) is the current lane's texture reconstruction filter and Tᵤ_{ᵢ}_{,v}_{ᵢ} represents a set of texels at integer coordinates (uᵢ, vᵢ) scaled by translated Dirac delta functions to compute a texture value. If the texture reconstruction filter is positive and normalized, then p_{c}(uᵢ, vᵢ)=f_{c}(uᵢ, vᵢ) and similarly pᵢ=fₗ, Equation 2 can be written as

$$\frac{{\sum }_{i}^{n} {f}_{c} ( {u}_{i} , {v}_{i} ) {T}_{{u}_{i} , {v}_{i}} / {p}_{i} ( {u}_{i} , {v}_{i} )}{{\sum }_{i}^{n} {f}_{c} ( {u}_{i} , {v}_{i} ) / {f}_{i} ( {u}_{i} , {v}_{i} )} . \qquad Equation 3$$

If the weights wᵢ are defined as

$${w}_{i} = \frac{{f}_{c} ( {u}_{i} , {v}_{i} )}{{f}_{i} ( {u}_{i} , {v}_{i} )} ,$$

Equation 3 becomes

$${\sum }_{i}^{n} \frac{{w}_{i}}{{\sum }_{j}^{n} {w}_{j}} {T}_{{u}_{i} , {v}_{i}} . \qquad Equation 4$$

Thus, the weights are normalized and sum to one, guaranteeing the estimator generates a convex combination of the filtered texels. As a result, constant texture regions have zero error.

In some embodiments, when contributed texels include all texels required for a small filter footprint (e.g., a 2×2 bilinear filter), the rendering process can perform exact filtering by blending texels in a deterministic manner. Exact filtering bypasses the stochastic estimator and generates a filter result matching a conventional bilinear technique. In some embodiments, detection of an entire set of required texels for a small footprint triggers a switch to exact filtering. In such cases, a lane identifies the presence of all unique texels (e.g., four unique texels) necessary for filtering and computes a fully blended output, eliminating reliance on any estimator. The exact filtering can be used under high magnification, where overlapping footprints can yield matching texels. Accordingly, the GPU can employ a hybrid strategy in which exact filtering is used when the contributed texels cover every needed sample, and weighted sampling is applied otherwise.

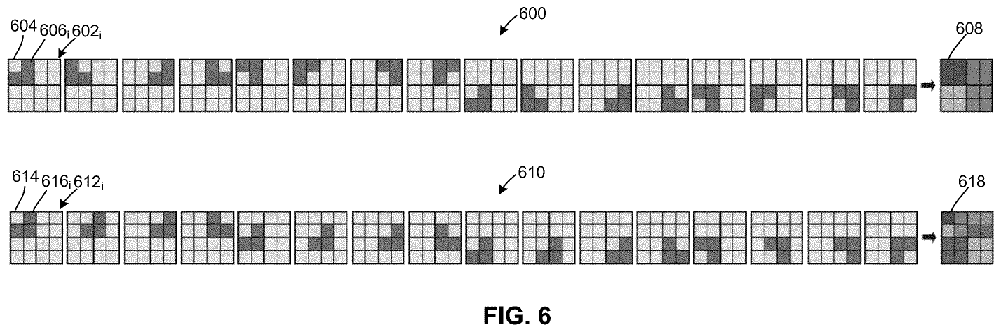

FIG. 6 illustrates two exemplar techniques for defining 2×2 footprints in a wave of size 16 arranged as a 4×4 grid of lanes, according to various embodiments. As shown, sets of footprints 600 and 610 include footprints 602ᵢ (referred to herein collectively as footprints 602 and individually as a footprint 602) and 612ᵢ (referred to herein collectively as footprints 612 and individually as a footprint 612), respectively. Each footprint specifies a target lane and a set of contributing lanes that provide texel samples to the target lane for purposes of computing a filtered color. For example, target lane 604 in footprint 602 reads texel samples from contributing lanes 606ᵢ (referred to herein collectively as contributing lanes 606 and individually as a contributing lane 606), and target lane 614 in footprint 612 reads texel samples from contributing lanes 616ᵢ (referred to herein collectively as contributing lanes 616 and individually as a contributing lane 616).

Illustratively, a wave associated with the footprints 602 in the set of footprints 600 can include 16 lanes that are configured to process different pixels in a 4×4 grid of pixels in parallel. Quad intrinsics permit texel samples to be shared among groups of four lanes (e.g., 2×2 quads) that start at even (x, y) coordinates, meaning each target lane (e.g., lane 604) in a quad relies on the same 2×2 footprint of contributor lanes (e.g., lanes 606ᵢ for the target lane 604). Under high magnification, 2×2 regions produce almost identical color after stochastic filtering, as illustrated by the diagram 608. The repetitive nature of quad-based footprints causes the same four texels to be reused by all lanes within a quad, which can produce larger patches of identical color.

In some embodiments, a spatiotemporal blue noise mask can be used to improve the sampling distribution at each lane. The spatiotemporal blue noise mask introduces randomness that minimizes clumping of selected texels and reduces correlated noise among adjacent pixels or across sequential frames. In some embodiments, scalar blue noise masks can be adapted to emphasize diagonal adjacency in each lane, decreasing the propensity for horizontal or vertical banding. In some embodiments, the void and cluster energy splatting function can be configured to splat twice as much energy to the neighbors in each fixed 2×2 quad.

A wave associated with the footprints 612 can also include 16 lanes that are configured to process different pixels in a 4×4 grid of pixels in parallel, but wave intrinsics are used for the footprints 612 in the set of footprints 610. In such cases, a target lane (e.g., lane 614) can select contributor lanes (e.g., lanes 616ᵢ for the target lane 614) anywhere within the 16-lane configuration, rather than remaining confined to hardware-defined quads. This flexibility allows the 2×2 footprints to extend beyond quad boundaries and minimize large uniform color areas. The example in diagram 618 shows a more scattered distribution of samples, which generally improves image quality under magnification by avoiding blocky artifacts.

Similar to the description above in conjunction with FIG. 5, both the set of footprints 600 and the set of footprints 610 can be used to exchange texel data through intrinsics, rather than requiring additional memory fetches, and filtered color values can be computed using the exchanged texel data according to the techniques described above in conjunction with FIG. 5. In the quad-based arrangement of the set of footprints 600, uniform regions become more pronounced, while the wave-based arrangement of the set of footprints 610 enables broader randomness and reduced repetitive color. Consequently, footprints defined through wave intrinsics can provide finer control over sharing patterns and can mitigate artifacts associated with magnified texture filtering.

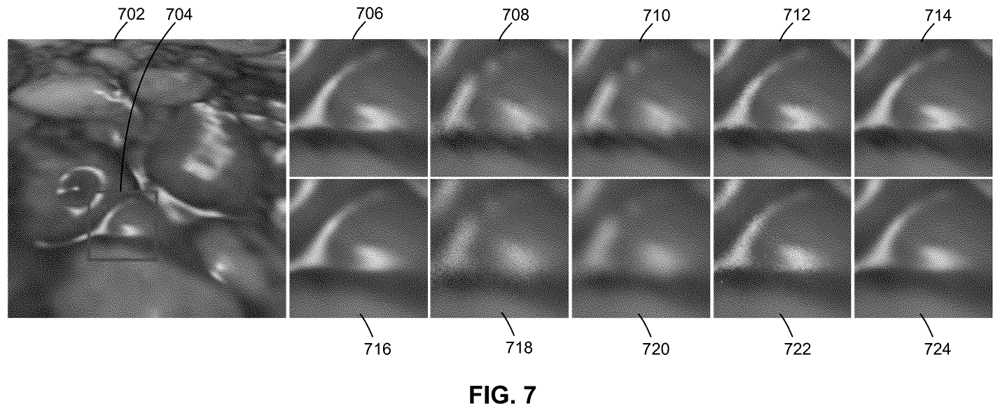

FIG. 7 illustrates exemplar texture filtering results generated using various techniques, according to various embodiments. As shown, example image 702 includes an image region 704, for which different filtering techniques have been applied to generate images 706-724 that enable visual comparison of the different filtering techniques and the improvements achieved through the disclosed techniques.

The generate images 706-724 are shown as two rows of images, each including five images, which compare filtering results under different techniques. Each row includes a ground truth image (706 for the bilinear case and 716 for the bicubic case), a baseline stochastic texture filtering (STF) result (708 and 718, respectively), a denoised STF result (710 and 720, respectively), a result obtained using the filtering techniques disclosed herein and pseudo-random footprints (712 and 722, respectively), and a denoised result using the filtering techniques disclosed herein and pseudo-random footprints (714 and 724, respectively). The ground truth images 706 and 716 provide a reference showing the texture without artifacts, noise, or approximation errors. The remaining images 708, 710, 712, 714, 718, 720, 722, and 724 can be compared to the ground truth images 706 and 716.

The top row of images 706, 708, 710, 712, and 714 demonstrates the effect of different filtering techniques with bilinear texture filtering. The STF image 708 exhibits noticeable noise and low-resolution interpolation, a characteristic outcome of standard single-sample stochastic filtering, where each pixel randomly selects a texel based on PDFs. The filtering errors in the STF image 708 are particularly pronounced in high-magnification regions, where texel selection randomness can lead to structured noise patterns.

The denoised STF image 710 is generated by applying a spatiotemporal denoising filter to the STF image 708, reducing noise resulting from texel reuse within a fixed deterministic footprint. While the denoiser reduces noise, blocky patterns formed by correlated texel sampling remain unresolved. The image 712 was generated using the filtering techniques disclosed herein. In particular, pseudo-random footprints, as described above in conjunction with FIG. 5, were used to generate the image 712, leading to more a uniform texel distribution and reduced structured noise. Compared to the STF image 708, the image 712 includes fewer correlated patterns, improving texture reconstruction without introducing excessive noise. A denoised version of the image 712, namely the image 714, further refines the image 712, resulting in a visually smooth image. Notably, the use of pseudo-random footprints prevents overrepresentation of specific texels, making the denoising process more effective compared to the denoised STF image 710, where deterministic footprints cause artifacts that are harder to remove.

The bottom row of images 716, 718, 720, 722, and 724 were generated using the same filtering techniques with bicubic B-spline filtering. The ground truth image 716 serves as a reference for the bicubic filtering results. The STF image 718 demonstrates loss of detail due to the stochastic sampling approach. The denoised STF image 720 improves upon the image 718, reducing noise but still suffering from artifacts compared to the ground truth image 716. The deterministic footprint selection in STF leads to clustering of similar texel values, preventing full restoration of details in the bicubic filter.

The image 722 generated using the techniques disclosed herein include an improvement in texture detail preservation compared to the STF image 718. By utilizing pseudorandom footprints, the disclosed filtering techniques reduce texel clustering and provide more uniform sample selection, enhancing the effectiveness of bicubic B-spline filtering. The denoised result of the image 722, namely the image 724, provides a high-quality reconstruction of the image 722.

Illustratively, the images 712, 714 722, and 724 that are generated using techniques disclosed herein show improvements including a reduction in structured artifacts, improved denoising results, and higher quality texture reconstruction relative to the images 708, 710, 718, and 720 that are generated using conventional approaches.

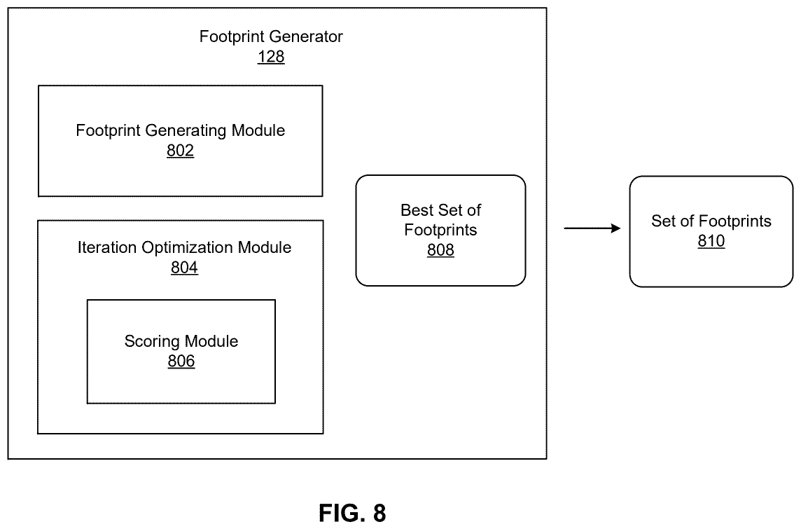

FIG. 8 is a more detailed illustration of the footprint generator 128 of FIG. 1, according to various embodiments. As shown, the footprint generator 128 includes, without limitation, a footprint generating module 802 and an iterative optimization module 804. The iterative optimization module 804 includes, without limitation, a scoring module 806. The footprint generator 128 is configured to generate one or more sets of pseudo-random footprints, such as the set of pseudo-random footprints 510 described above in conjunction with FIG. 5, for use in texture filtering according to the techniques disclosed herein.

In operation, the footprint generating module 802 generates a set of pseudo-random footprints for each pixel in a set of pixels. In some embodiments, the footprint generating module 802 can sample neighboring pixels to include in each footprint using, e, a Gaussian distribution. The set of pixels can correspond to pixels that will be processed by different lanes in a wave. Each footprint defines a pattern of contributor texels from surrounding pixels, enabling texel sampling across lanes within a wave, as described above in conjunction with FIG. 5.

After sets of pseudo-random footprints have been generated for each pixel, the iterative optimization module 804 performs iterative optimization to generate a set of footprints as follows. For each pixel within the set of pixels, the iterative optimization module 804 randomly selects a footprint from the set of footprints generated for the pixel. Together, the randomly selected footprints for the pixels form a set of footprints for the set of pixels. The iterative optimization module 804 computes a score for the set of footprints based on a histogram analysis of the number of times each pixel appears in the set of footprints. A histogram provides a statistical evaluation of texel reuse uniformity, similar to the analysis illustrated by the histogram 518 of FIG. 5. The histogram is used to prevent disproportionate sampling of pixels, which could otherwise introduce noise artifacts. In some embodiments, the scoring module 806 computes the score for the selected set of footprints using a scoring function that evaluates footprint coverage across the wave. For example, in some embodiments, the scoring module 806 can compute the score as the standard deviation of the histogram. In such cases, a higher score corresponds to a more uniform distribution of texel samples, mitigating overrepresentation of specific texels that can contribute to noise artifacts and filtering inaccuracies. Then, the iterative optimization module 804 determines whether the computed score is better (e.g., higher or lower, depending on the score that is computed) than the best (e.g., highest or lowest) previously recorded score for a set of footprints. Returning to the example in which the score is computed as a standard deviation, the iterative optimization module 804 could determine whether the standard deviation of the histogram is higher than a highest standard deviation that was computed for histograms associated with previously considered sets of footprints. If the computed score is better than the best prior score, then the iterative optimization module 804 stores the set of footprints as a set of footprints associated with the best score, shown as a best set of footprints 808. Storing the best set of footprints 808 facilitates convergence toward an optimized footprint selection that maximizes texel reuse efficiency while reducing sampling correlations. The foregoing steps can be repeated any number of times, such as for a fixed number of iterations (e.g., 1000 iterations), after which the footprint generator 128 can output the stored best set of footprints as a set of footprints 810 to use in texture filtering according to the techniques disclosed herein. For example, in some embodiments, the set of footprints 810 can be implemented within the parallel processing subsystem 112 of FIG. 1 and associated GPCs 208 and PPUs 202, illustrated in FIGS. 2 and 3. Additionally, in some embodiments, footprint generator 128 can generate more than one set of footprints. In such cases, the parallel processing subsystem 112 can cycle between different sets of footprints during the rendering of images.

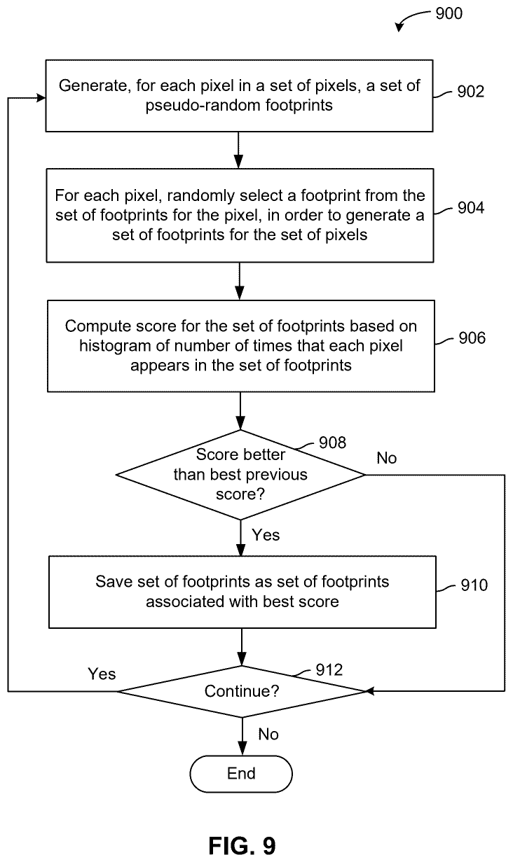

FIG. 9 is a flow diagram of method steps for generating and optimizing pseudo-random footprints for texel sharing within a wave, according to various embodiments. In some embodiments, the method steps can be performed on a computing system, such as the computer system 100 described above in conjunction with FIG. 1, which includes the parallel processing subsystem 112 that can perform texture filtering operations. Although the method steps are described in conjunction with the systems of FIGS. 1-8, persons skilled in the art will understand that any system configured to perform the method steps, in any order, falls within the scope of the present disclosure.

As shown, a method 900 begins at step 902, where the footprint generator 128 generates a set of pseudo-random footprints for each pixel in a set of pixels. The set of pixels can correspond to pixels that will be processed by different lanes in a wave. Each footprint defines a pattern of contributor texels from surrounding pixels, enabling texel sampling across lanes within a wave, as described above in conjunction with FIG. 5. In some embodiments, the footprint generator 128 can sample neighboring pixels to include in each footprint using, e.g., a Gaussian distribution. The pseudo-random footprints are designed to provide sample distribution variability across different rendering frames, reducing noise, as illustrated in FIG. 7. Footprints can be utilized within the parallel processing subsystem 112 in FIG. 1, utilizing parallel processing units (PPUs) such as 202 in FIG. 2, which execute filtering over different wave sizes, including 8, 16, 32, and 64 lanes, providing compatibility with various GPU architectures, as described above in conjunction with FIGS. 5 and 6.

At step 904, for each pixel within the set of pixels, the footprint generator 128 randomly selects a footprint from the set of footprints generated for the pixel. The selected footprints are implemented in a manner that distribute texel contributions, such as the contributor lanes 516 described above in conjunction with FIG. 5. The randomized selection of footprints can help to mitigate the overrepresentation of specific texels, thereby enhancing the efficacy of filtering operations.

At step 906, the footprint generator 128 computes a score for the selected set of footprints based on a histogram analysis of the number of times each pixel appears in the selected footprints. The histogram provides a statistical evaluation of texel reuse uniformity, similar to the analysis illustrated by the histogram 518 of FIG. 5. The histogram is used to prevent disproportionate sampling of pixels, which could otherwise introduce noise artifacts. In some embodiments, the footprint generator 128 computes the score for the selected set of footprints using a scoring function that evaluates footprint coverage across the wave. For example, in some embodiments, the score can be computed as the standard deviation of the histogram. In such cases, a higher score corresponds to a more uniform distribution of texel samples, mitigating overrepresentation of specific texels that can contribute to noise artifacts and filtering inaccuracies.

At step 908, the footprint generator 128 determines whether the computed score is better (e.g., higher or lower, depending on the score that is computed) than the best (e.g., highest or lowest) previously recorded score. Returning to the example in which the score is computed as a standard deviation, the footprint generator 128 could determine whether the standard deviation of the histogram is higher than a highest standard deviation that was computed for histograms associated with previously considered sets of footprints. If the computed score is not better than the best prior score (908—No), then the method 900 proceeds to decision step 912, where a determination is made regarding whether to continue the optimization process. If the computed score is better than the best prior score (908—Yes), then the method 900 proceeds to step 910, where the current set of footprints is stored as the set associated with the best score. Storing the best-scoring footprint set facilitates convergence toward an optimized footprint selection that maximizes texel reuse efficiency while reducing sampling correlations.

At step 912, the footprint generator 128 determines whether the optimization process should continue. For example, in some embodiments, the optimization process can be performed for a predefined number of iterations. If the process is to continue (912—Yes), then the method returns to step 902, where the footprint generator 128 generates a new set of pseudo-random footprints. This iterative approach enables the refinement of footprint selection through successive iterations, facilitating convergence toward an optimized set of footprints. If the optimization process is to be terminated (912—No), then the method 900 ends, finalizing the best-scoring set of footprints for use in texel sharing operations during rendering. For example, in some embodiments, the finalized footprint set can be implemented within the parallel processing subsystem 112 of FIG. 1 and associated GPCs 208 and PPUs 202, illustrated in FIGS. 2 and 3. In addition, in some embodiments, more than one set of footprints can be generated according to the method 900, and the parallel processing subsystem 112 can cycle between different sets of footprints during the rendering of images.

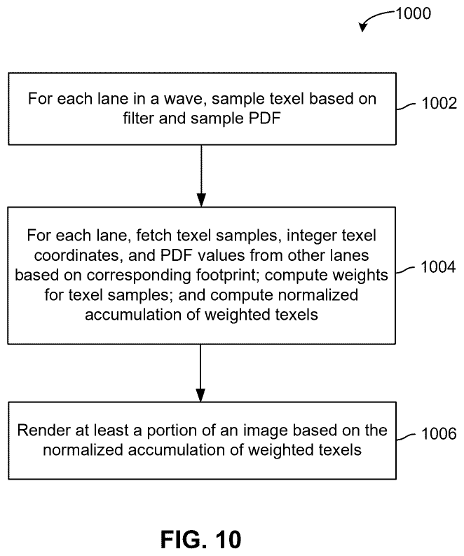

FIG. 10 is a flow diagram of method steps for performing rendering with texel sharing between lanes, according to various embodiments. In some embodiments, the method steps can be executed on a parallel processing subsystem, such as the parallel processing subsystem 112 described above in conjunction with FIGS. 1-3. Although the method steps are described in conjunction with the systems of FIGS. 1-8, persons skilled in the art will understand that any system configured to perform the method steps, in any order, falls within the scope of the present disclosure.

As shown, a method 1000 begins at step 1002, where each lane in a wave (which can execute on, e.g., SMs 310 of one of the GPCs 208 of the PPU 202, described above in conjunction with FIGS. 2-3) samples a texel based on a filter type and a sample PDF. The filter type can include bilinear filtering or bicubic B-spline filtering, as shown in FIG. 7, or any other technically feasible texture filtering technique. The sample PDF determines the likelihood of selecting a particular texel from the texture, ensuring that the selection follows the weighting rules of the applied filter. In some embodiments, the lane can sample integer coordinates (which can include fetching a value from memory) and (1) compute, using the sampled coordinates, the PDF indicating the value of the filter for the texel, and (2) obtain a texture value using the sampled coordinates, as shown above in Algorithm 1.

At step 1004, each lane uses wave (or quad) intrinsics to fetch texel samples, integer texel coordinates, and PDF values from other lanes within the wave, based on a corresponding sharing footprint (e.g., footprint 502 or 512 shown in FIG. 5 or 602 or 612 shown in FIG. 6); computes weights for the texel samples; and computes a normalized accumulation of weighted texels. The footprints define the set of contributor lanes, such as the lanes 516 shown in FIG. 5, that provide texel values to each target lane, such as the target lane 514 in FIG. 5. The footprints can be from a set of square footprints or a set of pseudo-random footprints that are generated according to, e.g., the method 900 of FIG. 9. In some embodiments, when more than one set of footprints is generated according to the method 900, a GPU can cycle between different sets of footprints during the rendering of images. In some embodiments, the ID of each lane in a footprint can be stored in a lookup table. In some embodiments, a lane can perform bit manipulations and arithmetic to compute the ID of each lane in the footprint, which is less computationally expensive than a lookup table. In some embodiments, to determine the ID of the lane in the footprint, a lane can perform a more efficient look-up in which a 32-bit value uses each bit to indicate whether the corresponding lane should be included or not.

Once the texel samples from other lanes, the integer texel coordinates, and the PDF values are obtained by each target lane, the target lanes each computes a set of weights (wᵢ) for each texel sample according to the WIS estimator of Equation 1. After computing the weights, each target lane computes a normalized accumulation of weighted texels that include the texel samples fetched from other lanes in the footprint, weighted by the corresponding weights, as shown in Algorithm 1. The normalized accumulation of weighted texels is a statistical estimate of a stochastically filtered texture that approximates the value of fully deterministic texture filtering by hardware. The weighted accumulation process enables a final computed filtered texel of each lane to remain within the convex hull of all texel samples, preventing any result from exceeding the minimum or maximum texel values among samples, thereby reducing filtering noise artifacts. Although described with respect to computing a normalized accumulation of weighted texels, in some embodiments, when contributed texels include all texels required for a small filter footprint (e.g., a 2×2 bilinear filter), the rendering process can perform exact filtering by blending texels in a deterministic manner, bypassing the stochastic estimator and generating a filter result matching a conventional bilinear technique, as described above in conjunction with FIG. 5.

At step 1006, the parallel processing subsystem 112 renders at least one portion of an image based on the normalized accumulation of weighted texels. The final computed filtered texels from step 1004 are used for texture reconstruction during rendering of an image, such as a standalone image or a frame within a video. The rendering can be performed for any technically feasible application, such as the rendering application 130 described above in conjunction with FIG. 1. The rendering can include other operations, such as lighting computations, shading computations, and/or denoising, which can be performed according to known techniques in some embodiments. For example, during ray tracing rendering, a traced ray could intersect the geometry of a textured object, and techniques disclosed herein can be used to compute filtered texture values based on the intersection as part of the rendering process.

In sum, techniques are disclosed for improving texture filtering by utilizing stochastic sampling in conjunction with inter-thread communication in GPUs. In some embodiments, a rendering application stochastically samples a first texel using a filter footprint that spans multiple threads or processing lanes, which can be implemented in software and/or hardware. The filter footprint, which can be square or pseudo-random in design, represents the spatial arrangement used to sample texels for filtering. A square footprint applies uniform sampling across a defined texture surface, while a pseudo-random footprint introduces controlled randomness sampling to minimize regular sampling patterns that can lead to artifacts. The rendering application uses the filter footprint to access additional texels from neighboring threads using inter-thread communication enabled by the SIMT and/or SIMD architectures in a GPU. Then, the rendering application assigns to each texel sample a weight calculated using a PDF that shows the probability of sampling that texel based on the filter footprint. The application normalizes the weights and applies the normalized weights to each texel to compute a weighted average, which can in turn be used to compute a pixel color.

At least one technical advantage of the disclosed techniques relative to the prior art is that, with the disclosed techniques, visual artifacts and noise commonly associated with stochastic texture filtering are reduced relative to conventional filtering approaches, particularly under conditions of magnification or when nonlinear shading, such as normal mapping or specular highlights, are present. By facilitating efficient sharing and reuse of texture samples across neighboring pixels, the disclosed techniques can be used to generate images that are relatively close in appearance to images generated using hardware filters. Furthermore, the disclosed techniques can achieve rendering improvements while maintaining a relatively low computational overhead, including no additional texture lookup cost compared to conventional STF. These technical advantages represent one or more technological improvements over prior art approaches.

1. In some embodiments, a computer-implemented method for rendering graphics images comprises for each lane included in a plurality of lanes in a wave, sampling a texel based on a filter to generate a texel sample, for each lane included in the plurality of lanes, computing a filtered value based on a plurality of the texel samples that are read from a corresponding plurality of lanes based on a footprint associated with the lane, and rendering at least one portion of a graphics image based on the filtered values computed for the plurality of lanes.

2. The computer-implemented method of clause 1, wherein computing the filtered value comprises for each lane included in the corresponding plurality of lanes reading one or more coordinates, a sampled probability distribution function (PDF) value, and a first texel sample associated with the lane, computing a weight based on the one or more coordinates and the sampled PDF value, adding the first texel sample, weighted by the weight, to an intermediate result, adding the weight to an accumulation of weights, and dividing the intermediate result by the accumulation of weights to compute the filtered value.

3. The computer-implemented method of clauses 1 or 2, wherein the plurality of texel samples are read from the corresponding plurality of lanes via wave intrinsics.

4. The computer-implemented method of any of clauses 1-3, wherein the plurality of texel samples are read from the corresponding plurality of lanes via quad intrinsics.

5. The computer-implemented method of any of clauses 1-4, wherein the footprint associated with the lane comprises at least one of a square footprint, a quad footprint, or a pseudo-random footprint.

6. The computer-implemented method of any of clauses 1-5, wherein the plurality of corresponding lanes are determined based on either a lookup table, one or more bit manipulations and arithmetic, or a value that includes a plurality of bits indicating the plurality of corresponding lanes.

7. The computer-implemented method of any of clauses 1-6, further comprising performing one or more iterative operations to generate a set of footprints that includes the footprint associated with the lane based on a histogram of times that pixels are included in the set of footprints.

8. The computer-implemented method of any of clauses 1-7, wherein computing a filtered value for each lane comprises computing a first filtered value for a first lane included in the plurality of lanes by reading a first plurality of the texel samples from a first plurality of lanes based on a first footprint associated with the first lane, and in response to determining the first plurality of texel samples can be used in an exact filtering technique, performing the exact filtering technique to compute the first filtered value based on the first plurality of texel samples.

9. The computer-implemented method of any of clauses 1-8, wherein rendering the at least one portion of the graphics image comprises performing at least one of one or more lighting operations or one or more shading operations.

10. The computer-implemented method of any of clauses 1-9, wherein the wave is executed via a graphics processing unit (GPU).

11. In some embodiments, one or more non-transitory computer-readable media store instructions that, when executed by at least one processor, cause the at least one processor to perform the steps of for each lane included in a plurality of lanes in a wave, sampling a texel based on a filter to generate a texel sample, for each lane included in the plurality of lanes, computing a filtered value based on a plurality of the texel samples that are read from a corresponding plurality of lanes based on a footprint associated with the lane, and rendering at least one portion of a graphics image based on the filtered values computed for the plurality of lanes.

12. The one or more non-transitory computer-readable media of clause 11, wherein computing the filtered value comprises for each lane included in the corresponding plurality of lanes reading one or more coordinates, a sampled probability distribution function (PDF) value, and a first texel sample associated with the lane, computing a weight based on the one or more coordinates and the sampled PDF value, adding the first texel sample, weighted by the weight, to an intermediate result, adding the weight to an accumulation of weights, and dividing the intermediate result by the accumulation of weights to compute the filtered value.

13. The one or more non-transitory computer-readable media of clauses 11 or 12, wherein the plurality of texel samples are read from the corresponding plurality of lanes via at least one of wave intrinsics or quad intrinsics.

14. The one or more non-transitory computer-readable media of any of clauses 11-13, wherein the footprint associated with the lane comprises at least one of a square footprint, a pseudo-random footprint, or a quad footprint.

15. The one or more non-transitory computer-readable media of any of clauses 11-14, wherein computing the filtered value comprises performing an interpolation to blend the plurality of the texel samples.

16. The one or more non-transitory computer-readable media of any of clauses 11-15, wherein the plurality of lanes correspond to a plurality of neighboring pixels.

17. The one or more non-transitory computer-readable media of any of clauses 11-16, wherein rendering the at least one portion of the graphics image comprises performing one or more denoising operations on the at least one portion of the graphics image.

18. The one or more non-transitory computer-readable media of any of clauses 11-17, wherein the filter comprises either a bilinear filter or a bicubic filter.

19. The one or more non-transitory computer-readable media of any of clauses 11-18, wherein the at least one processor includes a graphics processing unit (GPU).

20. In some embodiments, a system comprises one or more memories storing instructions, and one or more processors that are coupled to the one or more memories and, when executing the instructions, are configured to for each lane included in a plurality of lanes in a wave, sample a texel based on a filter to generate a texel sample, for each lane included in the plurality of lanes, compute a filtered value based on a plurality of the texel samples that are read from a corresponding plurality of lanes based on a footprint associated with the lane, and render at least one portion of a graphics image based on the filtered values computed for the plurality of lanes.

1. In some embodiments, a computer-implemented method for configuring a processor comprises generating a set of footprints based on a histogram of times that each pixel from a set of pixels is included in the set of footprints, wherein each footprint included in the set of footprints indicates a plurality of pixels around a target pixel to read texel samples from, and configuring the processor to perform texture filtering using the set of footprints when rendering one or more graphics images.

2. The computer-implemented method of clause 1, wherein generating the set of footprints comprises generating, for each pixel included in the set of pixels, a corresponding set of footprints, for each pixel included in the set of pixels, selecting a footprint from the corresponding set of footprints, wherein the set of footprints includes the footprints that are selected, computing a score based on the histogram, and determining the score is a highest or a lowest score among one or more scores computed for one or more sets of footprints.

3. The computer-implemented method of clauses 1 or 2, wherein the score is computed based on a standard deviation of the histogram.

4. The computer-implemented method of any of clauses 1-3, wherein the plurality of pixels around the target pixel includes a pseudo-random selection of pixels from the set of pixels.

5. The computer-implemented method of any of clauses 1-4, wherein configuring the processor comprises storing the set of footprints in one or more lookup tables on the processor.

6. The computer-implemented method of any of clauses 1-5, wherein the processor is configured to compute one or more pixels included in each footprint included in the set of footprints using one or more bit manipulations and arithmetic.

7. The computer-implemented method of any of clauses 1-6, wherein configuring the processor comprises storing, on the processor, each footprint included in the set of footprints as a value that includes a plurality of bits indicating whether corresponding pixels are included in the footprint.

8. The computer-implemented method of any of clauses 1-7, wherein the processor executes a plurality of lanes in a wave, and each lane included in the plurality of lane processes a corresponding pixel included in the set of pixels.

9. The computer-implemented method of any of clauses 1-8, wherein the processor is configured to for each lane included in a plurality of lanes in a wave, sample a texel based on a filter to generate a texel sample, for each lane included in the plurality of lanes, compute a filtered value based on a plurality of the texel samples that are read from a corresponding plurality of lanes based on a footprint included in the set of footprints that is associated with a pixel that the lane is processing, and render at least one portion of a graphics image based on the filtered values computed for the plurality of lanes.

10. The computer-implemented method of any of clauses 1-9, wherein the processor comprises a graphics processing unit (GPU).

11. In some embodiments, one or more non-transitory computer-readable media store instructions that, when executed by at least one processor, cause the at least one processor to perform the steps of generating a set of footprints based on a histogram of times that each pixel from a set of pixels is included in the set of footprints, wherein each footprint included in the set of footprints indicates a plurality of pixels around a target pixel to read texel samples from, and configuring one or more processors to perform texture filtering using the set of footprints when rendering one or more graphics images.

12. The one or more non-transitory computer-readable media of clause 11, wherein generating the set of footprints comprises performing one or more iterative optimization operations.

13. The one or more non-transitory computer-readable media of clauses 11 or 12, wherein generating the set of footprints comprises generating, for each pixel included in the set of pixels, a corresponding set of pseudo-random footprints, for each pixel included in the set of pixels, selecting a pseudo-random footprint from the corresponding set of pseudo-random footprints, wherein the set of footprints includes the pseudo-random footprints that are selected, computing a score based on the histogram, and determining the score is a highest or a lowest score among one or more scores computed for one or more sets of footprints.

14. The one or more non-transitory computer-readable media of any of clauses 11-13, wherein the score is computed based on a standard deviation of the histogram.

5. The one or more non-transitory computer-readable media of any of clauses 11-14, wherein the plurality of pixels around the target pixel are sampled based on a Gaussian distribution.

16. The one or more non-transitory computer-readable media of any of clauses 11-15, wherein configuring the one or more processors comprises storing the set of footprints in one or more lookup tables on the one or more processors.

17. The one or more non-transitory computer-readable media of any of clauses 11-16, wherein configuring the one or more processors comprises storing, on the one or more processors, each footprint included in the set of footprints as a value that includes a plurality of bits indicating whether corresponding pixels are included in the footprint.

18. The one or more non-transitory computer-readable media of any of clauses 11-17, wherein the one or more processors are configured to compute one or more pixels included in each footprint included in the set of footprints using one or more bit manipulations and arithmetic.

19. The one or more non-transitory computer-readable media of any of clauses 11-18, wherein the set of pixels form a rectangular region of the one or more graphics images.

20. In some embodiments, a system comprises one or more memories storing instructions, and one or more processors that are coupled to the one or more memories and, when executing the instructions, are configured to generate a set of footprints based on a histogram of times that each pixel from a set of pixels is included in the set of footprints, wherein each footprint included in the set of footprints indicates a plurality of pixels around a target pixel to read texel samples from, and configure at least one processor to perform texture filtering using the set of footprints when rendering one or more graphics images.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for configuring a processor, the method comprising:
generating a set of footprints based on a histogram of times that each pixel from a set of pixels is included in the set of footprints, wherein each footprint included in the set of footprints indicates a plurality of pixels around a target pixel to read texel samples from; and
configuring the processor to perform texture filtering using the set of footprints when rendering one or more graphics images.

2. The computer-implemented method of claim 1, wherein generating the set of footprints comprises:
generating, for each pixel included in the set of pixels, a corresponding set of footprints;
for each pixel included in the set of pixels, selecting a footprint from the corresponding set of footprints, wherein the set of footprints includes the footprints that are selected;
computing a score based on the histogram; and
determining the score is a highest or a lowest score among one or more scores computed for one or more sets of footprints.

3. The computer-implemented method of claim 2, wherein the score is computed based on a standard deviation of the histogram.

4. The computer-implemented method of claim 1, wherein the plurality of pixels around the target pixel includes a pseudo-random selection of pixels from the set of pixels.

5. The computer-implemented method of claim 1, wherein configuring the processor comprises storing the set of footprints in one or more lookup tables on the processor.

6. The computer-implemented method of claim 1, wherein the processor is configured to compute one or more pixels included in each footprint included in the set of footprints using one or more bit manipulations and arithmetic.

7. The computer-implemented method of claim 1, wherein configuring the processor comprises storing, on the processor, each footprint included in the set of footprints as a value that includes a plurality of bits indicating whether corresponding pixels are included in the footprint.

8. The computer-implemented method of claim 1, wherein the processor executes a plurality of lanes in a wave, and each lane included in the plurality of lane processes a corresponding pixel included in the set of pixels.

9. The computer-implemented method of claim 1, wherein the processor is configured to:
for each lane included in a plurality of lanes in a wave, sample a texel based on a filter to generate a texel sample;
for each lane included in the plurality of lanes, compute a filtered value based on a plurality of the texel samples that are read from a corresponding plurality of lanes based on a footprint included in the set of footprints that is associated with a pixel that the lane is processing; and
render at least one portion of a graphics image based on the filtered values computed for the plurality of lanes.

10. The computer-implemented method of claim 1, wherein the processor comprises a graphics processing unit (GPU).

11. One or more non-transitory computer-readable media storing instructions that, when executed by at least one processor, cause the at least one processor to perform the steps of:
generating a set of footprints based on a histogram of times that each pixel from a set of pixels is included in the set of footprints, wherein each footprint included in the set of footprints indicates a plurality of pixels around a target pixel to read texel samples from; and
configuring one or more processors to perform texture filtering using the set of footprints when rendering one or more graphics images.

12. The one or more non-transitory computer-readable media of claim 11, wherein generating the set of footprints comprises performing one or more iterative optimization operations.

13. The one or more non-transitory computer-readable media of claim 11, wherein generating the set of footprints comprises:
generating, for each pixel included in the set of pixels, a corresponding set of pseudo-random footprints;
for each pixel included in the set of pixels, selecting a pseudo-random footprint from the corresponding set of pseudo-random footprints, wherein the set of footprints includes the pseudo-random footprints that are selected;
computing a score based on the histogram; and
determining the score is a highest or a lowest score among one or more scores computed for one or more sets of footprints.

14. The one or more non-transitory computer-readable media of claim 13, wherein the score is computed based on a standard deviation of the histogram.

15. The one or more non-transitory computer-readable media of claim 11, wherein the plurality of pixels around the target pixel are sampled based on a Gaussian distribution.

16. The one or more non-transitory computer-readable media of claim 11, wherein configuring the one or more processors comprises storing the set of footprints in one or more lookup tables on the one or more processors.

17. The one or more non-transitory computer-readable media of claim 11, wherein configuring the one or more processors comprises storing, on the one or more processors, each footprint included in the set of footprints as a value that includes a plurality of bits indicating whether corresponding pixels are included in the footprint.

18. The one or more non-transitory computer-readable media of claim 11, wherein the one or more processors are configured to compute one or more pixels included in each footprint included in the set of footprints using one or more bit manipulations and arithmetic.

19. The one or more non-transitory computer-readable media of claim 11, wherein the set of pixels form a rectangular region of the one or more graphics images.

20. A system, comprising:
one or more memories storing instructions; and
one or more processors that are coupled to the one or more memories and, when executing the instructions, are configured to:
generate a set of footprints based on a histogram of times that each pixel from a set of pixels is included in the set of footprints, wherein each footprint included in the set of footprints indicates a plurality of pixels around a target pixel to read texel samples from, and
configure at least one processor to perform texture filtering using the set of footprints when rendering one or more graphics images.
